(19) United States
(12) Patent Application Publication
(10) Pub. No.: US 2006/0036454 A1
(43) Pub. Date: Feb. 16, 2006

(54) Business method suitable for preparing and delivering a custom (non-prescription, non-cosmetic) personal care composition through human interaction in a retail point-of-sale environment

(76) Inventor: Carlton Lindley Henderson, Vancouver, WA (US)

Correspondence Address: GREGORY GAULT;14216 NORDHOFF ST., PANORAMA CITY, CA, 91402, US

(21) Appl. No.: 10/916,794

(22) Filed: Aug. 11, 2004

(51) Int. Cl. G06Q 99/00

(52) U.S. Cl. 705/1

(57) ABSTRACT

A business system including related processes and methods is described for preparing and delivering a customized, (non-prescription, non-cosmetic) personal care product to a consumer at a location, (typically the point of sale,) remote from a second location in which a (non-prescription, non-cosmetic) personal care product base composition is prepared. A selection of customizing agents of different classes with a common vehicle is made available to the consumer for custom formulation of a (non-prescription, non-cosmetic) personal care product with the desired attributes. The business method typically includes a plurality of product base options, a plurality of fragrance options, and a plurality of customizing agent options that may contain benefit agents, botanical extracts, active ingredients for skin and hair, and the like. Efficient and cost-effective ingredient storage, supply distribution, mixing, labeling, finished product tracking and packaging mechanisms and processes are also described.

### CROSS-REFERENCE TO RELATED APPLICATIONS

U.S. Patent Documents

| | | |
|---|---|---|
| 5,842,441 | December 1998 | Gjerl.o.slashed.v |
| 5,918,568 | July 1999 | Gjerl.o.slashed.v |
| 5,972,322 | October 1999 | Rath et al. |
| 5,993,792 | November 1999 | Rath et al. |
| 6,598,627 | July 2003 | Manzari et al. |

### STATEMENT REGARDING FEDERALLY SPONSORED RESEARCH OR DEVELOPMENT

This invention was not federally sponsored.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Many (non-prescription, non-cosmetic) personal care products such as body wash, facial cleansing gel, hair shampoo, hair conditioner, face lotion and other (non-prescription, non-cosmetic) personal care products that are currently available are provided as prepared formulations. A drawback of such products is that the user cannot alter the formulation to accommodate their particular skin and hair characteristics, personal preferences, or to provide specialized treatment. A further drawback is the uncertainty of the age and freshness of the prepared formulation that may have been prepared many months or years before the product was sold.

Multiple-part product kits that contain separate components of e.g. a hair shampoo, hair conditioner, cosmetics, or other (non-prescription, non-cosmetic) personal care products are available from some professional salons and some retail (non-prescription, non-cosmetic) personal care outlets. However, the user is still unable to customize the individual formulations in relation to the consumer's unique (non-prescription, non-cosmetic) personal care preferences, allergies, skin conditions, religious and cultural restrictions, social beliefs, political practices, and other requirements.

Therefore, one aspect of the invention is to provide a business method that enables a user to formulate a variety of (non-prescription, non-cosmetic) personal care product compositions to best suit the needs of the consumer.

Another aspect of the invention is that beyond the need for custom formulations due to skin sensitivities and allergies, such novel product personalization may also address consumer preferences ranging from kosher, all-natural, preservative free, certified organic, and/or vegan/vegetarian formulations, to non-animal testing, and 100% post consumer recycled packaging. Another aspect of the invention is that formulations are tailored in the individual quantity requested by the consumer. Another aspect of the invention is to provide a business method whereby individualized on-demand face-to-face consultation, consumer education, and technical assistance is available in the formulation process ending in a customized (non-prescription, non-cosmetic) personal care product. Another aspect of the invention is to provide a business method with a plurality of customizing agent dispensing stations, and a plurality of (non-prescription, non-cosmetic) personal care product base dispensing stations designed to efficiently prepare stable (non-prescription, non-cosmetic) personal care product which are freshly blended while the consumer waits. Another aspect of the invention is to more consistently address the multiple complexities of consumer choice in one location, more efficiently utilizing trained, knowledgeable personnel with whom the consumer may build an ongoing trust relationship. Another aspect of the invention is to address the multiple complexities of consumer need and consumer choice in each location, more efficiently utilizing space, equipment, supply inventories, distribution systems, advertising, time and labor, thereby increasing business profitability while conserving resources and maintaining quality of product and service to the consumer without unnecessary expense. Another aspect of the invention is to mix and package the (non-prescription, non-cosmetic) personal care products in a cost-efficient, yet environmentally conscious manner based upon jurisdictional regulations and environmental needs, including but not limited to hard or soft water conditions, and waste disposal concerns. Another aspect of the invention is to modify formulations or substitute ingredients, which may become temporarily or permanently unavailable or non-cost-effective due to market fluctuations of particular commodities or regulation, without undue stress to or non-consultation with the consumer.

Another aspect of the invention is the novel incorporation of cost-effective, consumer friendly, hygienically standardized, readily available and commonly understood, labor adaptive model of the retail point-of-sale food manufacturing environment and utilizing the industry standard types of (or similar to:) to containers, dispensers, machines, utensils, and/or floor plans commonly associated with point-of-sale food item manufacturing outlets, such as: delicatessens, sandwich shops, coffee carts, food kiosks, ice cream parlors, coffee houses, cafeterias, cocktail bars and snack bars, thereby providing multiple benefits to the consumer, the laborer, the producer, the ingredient supplier, the investor, the marketer, the franchiser and the franchisee, and other persons and entities holding vested interests.

### SUMMARY OF THE INVENTION

A business method is provided for preparing and delivering a customized, (non-prescription, non-cosmetic) personal care product for a consumer typically at a location remote from a second location in which a (non-prescription, non-cosmetic) personal care product base composition is prepared. The business method comprises a compounding of a plurality of (non-prescription, non-cosmetic) personal care base compositions each contained in dispensing station and optional variants from one or more classes of customizing agents each contained in a dispensing station. The consumer selects, in any sequence, one (non-prescription, non-cosmetic) personal care base composition and optionally, one or more variants from separate classes of customizing agents, such as a fragrance and a benefit agent. The (non-consumer) preparer doses, in appropriate sequence, the consumer selected (non-prescription, non-cosmetic) personal care base composition, and optional customizing agents, mixes the contents until uniform, packages the finished product in such appropriate packaging as dictated by product type and influenced by consumer preferences, and labels the container using the inventive business method.

The inventive compounding, packaging and marketing business method is preferably used with (non-prescription, non-cosmetic) personal care product base compositions including cleansing and conditioning product bases useful for formulating body wash, body lotion, body creams, body butters, body mist spray, tanning and sun protection products, hydro-alcoholic toner, facial cleansing gel, waterless cleanser, hair shampoo, hair conditioner, face lotion, bubble bath, bath oils, deodorants, bar soaps, hand soaps, lip balm, massage oils, and similar non-food, externally applied (non-prescription, non-cosmetic) body care products.

Where applicable, the inventive compounding, packaging and marketing business method adopts, incorporates, and utilizes various business practices, methods, equipment, processes, and concepts commonly associated with the retail point-of-sale food-manufacturing environment.

### BRIEF DESCRIPTION OF THE DRAWINGS

Not Applicable

### DETAILED DESCRIPTION OF THE INVENTION

In one aspect of the invention is a process for preparing and delivering a customized, (non-prescription, non-cosmetic) personal care product to a consumer at a location remote from a second location in which a (non-prescription, non-cosmetic) personal care product base is prepared, comprising:
a. a plurality of measuring options for determining amounts of at least one of said product base and an optional plurality of customizing agents to be blended into a container;
b. a plurality of dispensing options, each interacting with one of said measuring options, for dispensing said amounts of at least one of said product base and an optional plurality of customizing agents into said container;
c. an external mixing device for blending said product base and customizing agents after being dispensed into said container by stirring, blending, mixing and/or agitating said ingredients in a processing container and/or consumer use container; and
d. a labeling device for labeling said consumer use container with the ingredients contained in the custom blended product.

In another aspect of the invention is a business method for preparing and delivering a customized, (non-prescription, non-cosmetic) personal care product to a consumer at a location remote from a second location in which a (non-prescription, non-cosmetic) personal care product base is prepared, comprising:
a. a plurality of measuring options for determining amounts of at least one of said product base and an optional plurality of customizing agents to be blended into a container;
b. a plurality of dispensing options, each interacting with one of said measuring options, for dispensing said amounts of at least one of said product base and an optional plurality of customizing agents into said container;
c. an external mixing device for blending said product base and customizing agents after being dispensed into said container by stirring, blending, mixing and/or agitating said ingredients in a processing container and/or consumer use container; and
d. a labeling device for labeling said consumer use container with the ingredients contained in the custom blended product.

Preferably, the plurality of dispensing options and equipment, mixing processes and equipment, and point of sale containers are situated in a model of the retail point-of-sale food manufacturing environment and utilizing the industry standard types of (or similar to:) to containers, dispensers, machines, utensils, and/or floor plans commonly associated with point-of-sale food item manufacturing outlets, such as: delicatessens, sandwich shops, coffee carts, food kiosks, ice cream parlors, coffee houses, cafeterias, cocktail bars and snack bars.

Preferably, the business method or process has a plurality of dispensing options with at least one storage container for containing product; at least one measuring device for measuring product to be dispensed; and at least one device for dispensing measured product into appropriate packaging.

Preferably the inventive dispensing business method has a plurality of user stations to allow the simultaneous preparation of customized (non-prescription, non-cosmetic) personal care products.

Internal or external mixers may generate the mixing motion preparing and delivering agitation and mixing of product base and customizing agents. Preferably, the internal or external mixer has a container holder that can accommodate a plurality of consumer containers of the same or different volumes, thus increasing productivity.

Preferably, the finished product will utilize a functional, yet minimal approach to packaging. Preferably, the finished product would be packaged for bulk refill of a previously used consumer provided container. An example of such bulk packaging option might be a vacuum-sealed plastic bag or pouch. In non-bulk packaging, (where applicable) the finished product container has a neck for facilitating the dispensing of a flow controlled or extruded personal care product.

Particularly preferred, in such non-bulk finished product packaging, and where applicable is a threaded or flanged neck for use with a cap (with or without an integrated orifice), or a pump dispenser, which is designed to securely fit on the neck, or the like.

In another aspect of the invention, an internal or external labeling device applies a customized label to the container identifying the components of the base formula and any optional, dosed customizing agents actually contained in the finished product container. The labeling device may produce the label by any suitable means, preferably by a computer interfaced with a printer which allows for the preparer or salesperson to input the consumer's custom product selections and accesses a database of ingredients contained in the available product bases and customizing agent compositions to produce a customized label.

The same or a different computer printer combination may also be used to insert a code on the label, e.g. a machine-readable bar code or the like, capable of tracking the identity of both the product and the consumer for later reference. In this way, the consumer can easily reorder the custom product from the same location the product was purchased or from a remote location. The consumer may also return to the store or kiosk and allow the previous label to be scanned thus facilitating the purchase of additional product.

In another aspect, the inventive business method or process produces custom products of convenient volume to facilitate consumer use. Preferably, the business method is designed to accommodate a consumer container for the final product having a volume under about 1 liter.

The foregoing description and examples illustrate selected embodiments of the present invention. In light there of variations and modifications will be suggested to one skilled in the art, all of which are within the scope and spirit of this invention.

I claim:

1. A business system and related methods and processes for the plural of professional consultation with the consumer and/or retail purchaser of, professional (not consumer self-service style) manufacturing and/or compounding of, packaging of, labeling of, and delivery of customized “made-to-order” retail (non-prescription, non-cosmetic) personal care products designed and intended for consumer applied, “home use” personal consumption to individual retail customers that is performed in a “while-you-wait,” “drive thru” and/or “call in—take out” retail environment by means of non-automated hand-crafting a customized, (non-prescription, non-cosmetic) personal care product to a consumer at a location remote from a second location in which a (non-prescription, non-cosmetic) personal care product base is prepared, comprising:
a. a plurality of measuring options and devices for determining amounts of at least one of said product base and optionally, one or more customizing agents to be blended into a container;
b. a plurality of interactive, human decision-making and labor process related to selection and application of dispensing options and devices, and/or measuring options and devices, for dispensing said amounts of at least one of said product base and optionally, one or more customizing agents into said container;
c. a mixing device for blending said product base and optional customizing agents after being dispensed into said container by agitating the contents of said container and/or of said container itself; and
d. a labeling device and/or process for labeling said container, identifying the specific ingredients contained in the custom blended product

2. The business method, process and system of claim 1 wherein said plurality of dispensing options and equipment, mixing processes and equipment, and point of sale containers are situated in a model of the retail point-of-sale environment similar to a food manufacturing environment and utilizing the industry standard types of (or similar to:) to containers, dispensers, machines, utensils, and/or floor plans commonly associated with point-of-sale food item manufacturing outlets, such as: delicatessens, sandwich shops, coffee carts, food kiosks, ice cream parlors, coffee houses, cafeterias, cocktail bars and snack bars.

3. The business method, process and system of claim 1, wherein said plurality of dispensing options each has at least one storage container for containing product; at least one measuring device for measuring product to be dispensed; at least one outlet for dispensing product; and requires human interaction other than the consumer and/or retail purchaser for completing the compounding, mixing, packaging and/or labeling of the end product.

4. The business method, process, and system of claim 1, wherein the production of documentation, training, floor plans, site preparation, location selection and other related business development and operation support activities for preparing and delivering a point-of-sale compounding of made-to-order (non-prescription, non-cosmetic) personal care products designed for consumer applied, home use consumption to individual retail customers by hand-crafting and delivering a customized, (non-prescription, non-cosmetic) personal care product to a consumer at a location remote from a second location in which a (non-prescription, non-cosmetic) personal care product base is prepared by other business methods, processes and systems stated herein.
